(19) United States
(12) Patent Application Publication
(10) Pub. No.: US 2014/0108289 A1
(43) Pub. Date: Apr. 17, 2014

(54) SYSTEM AND METHOD FOR USING A HYBRID BUSINESS CARD

(71) Applicant: CardSpark, Inc., New York, NY (US)

(72) Inventors: Nadav EITAN, New York, NY (US); Jonathan CHASHPER, Rockville, MD (US)

(73) Assignee: CardSpark, Inc., New York, NY (US)

(21) Appl. No.: 14/052,098

(22) Filed: Oct. 11, 2013

Related U.S. Application Data
(60) Provisional application No. 61/712,457, filed on Oct. 11, 2012.

(51) Int. Cl. G06Q 10/00; G06F 17/30

(52) U.S. Cl. CPC G06Q 10/00; G06F 17/30879
USPC 705/342; 235/375

(57) ABSTRACT

A system and method is provided for exchanging information. Information may be received relating to a business card such as a hybrid business card. The business card may have printed thereon information providing a link to a virtual profile for a first user. Identity information for a second user may be received. The identity information may be associated with the information related to the hybrid business card. In response to receiving the information relating to the business card, the second user may be provided with access to the virtual profile including information relating to the first user or to an organization associated with the first user. Interactions may be recorded of the second user related to the first user. The recorded interactions of the second user may be monitored and reported to the first user.

### CROSS-REFERENCE TO RELATED APPLICATIONS

This application claims the benefit of prior U.S. Provisional Application Ser. No. 61/712,457, filed Oct. 11, 2012, which is incorporated by reference herein in its entirety.

### FIELD OF THE INVENTION

Embodiments of the invention relate to the field of offline networking in which a user hands out for example physical business cards to colleagues as well as online networking in which users communicate for example over social media networks via virtual profiles.

### BACKGROUND OF THE INVENTION

A recent growth in social media networking has created a surge in online communication. In social media networks, users typically connect via digital devices using user profile information, such as, usernames, e-mail addresses, etc. However, initial contact between users still occurs largely in-person, where contact information is typically shared using business cards and other physical or printed media.

There is therefore a great need in the art to bridge the gap between offline in-person networking using printed media and online social media networking using digital media.

### SUMMARY OF EMBODIMENTS OF THE INVENTION

Embodiments of the invention include a hybrid business card system and method to integrate conventional or augmented printed business cards into the social media environment for effectively overcoming the aforementioned difficulties inherent in the art.

According to an embodiment of the invention, a social media environment may be provided for exchanging hybrid business cards. A hybrid business card may be a physical business card (e.g., a thin cardboard card size: 95.25×57.15 mm or 3.75×2.25 in; 89×51 mm or 3.5×2 in, or another size), e.g. for a user to hand out to colleagues at in-person meetings, linked to a virtual profile, e.g. of the user's social media page, mobile application page, web application page, and/or microsite. The hybrid business card may have printed thereon an encoded object or “virtual key,” e.g., a matrix barcode such as a QR code or uniform resource locator (URL), encoding or being a link such as an Internet address or IP address to the user's website or microsite. The business card may be a conventional business card, and the link or encoded object may be for example a name and/or telephone number and/or e-mail address or other contact information as printed on conventional business cards. The recipient of the hybrid business card may scan the encoded object, e.g., using a camera on a mobile phone, to access the virtual profile, e.g. to view and save the user's digital profile information. In turn, the profile information of the card recipient may be reciprocally shared with the user. Once connected, the recipient and the user may continue their in-person meeting online in a virtual social media environment. In another embodiment, the hybrid business card may include a digital business card (e.g. with no physical component) that may be shared and accessed digitally, e.g., via electronic mail (e-mail), text messaging, near field communication (NFC), augmented reality and/or other digital communication platforms.

According to an embodiment of the invention, a web dashboard may be provided to monitor and display web analytics for hybrid business card in real-time, such as, the number of recipients that scan each user's hybrid business card, the number of recipients that access the virtual profile of each user, the number of contacts in the user's network, and the rate of reciprocal profile sharing between card recipients and card providers.

According to an embodiment of the invention, a contact map may be provided to visualize each user's network of virtual contacts. A user's contacts may include hybrid business card recipients that have scanned the user's hybrid business card directly, or who are connected to other users who have, and/or other virtual contacts that have connected to the user via the user's digital business card (e.g. without scanning the users' physical business card). In some embodiments, each time a user's hybrid business card is scanned, the card recipient joins not only the user's network, but all networks in which the user is already connected. In some embodiments, users may be blocked from sharing contacts due to privacy restrictions. According to an embodiment of the invention, the nodes of the contact map may show the geographic locations, e.g., overlaid on top of a map, where the user's hybrid business card was used, shared and/or scanned. For example, when a request for a user's virtual profile information is received, a server may query the requesting device for its location information (e.g. global positioning system (gps) coordinates) to identify the location of the request.

According to an embodiment of the invention, a web dashboard may be provided to manage the content of the virtual profile and web analytics. Authorized users may edit the virtual profile to provide dynamic content to the recipient of the hybrid business card. When the virtual profile information is updated, updates may be automatically sent to each user's virtual contacts. The virtual profile content may be targeted to individuals or groups of recipients (e.g. friends may have access to relatively more personal information compared to colleagues), targeted based on recipient location (e.g. contacts located in New York may have access to English language profile information, while contacts located in Tokyo may have access to Japanese language profile information), and/or targeted based on the user's schedule (e.g. profile information accessed during the week of a conference may have event-specific information).

According to an embodiment of the invention, a hybrid business card may act as a “living” or dynamic business card that combines an offline physical contact card with an online digital counterpart.

According to an embodiment of the invention, a system and method is provided for exchanging information. Information may be received relating to business cards such as a hybrid business card. The hybrid business card may have printed thereon information providing a link to a virtual profile for a first user. Identity information for a second user may be received. The identity information may be associated with the information related to the hybrid business card. In response to receiving the information relating to the hybrid business card, the second user may be provided with access to the virtual profile including information relating to the first user or to an organization associated with the first user. Interactions may be recorded of the second user related to the first user. The recorded interactions of the second user may be monitored and reported to the first user.

According to an embodiment of the invention, a system and method is provided for using a business card such as a hybrid business card associated with a user, the hybrid business card having printed thereon an encoded object providing a link to a virtual profile for the user. A request may be received from a device scanning the encoded object. In response to receiving the request, the scanning device may be provided with access to the link to the virtual profile.

According to an embodiment of the invention, a system and method is provided for providing a social media environment for sharing business cards. A request may be received for digital profile information of a user. The user may be identified for the request using a business card associated with the user. A network of contacts may be generated for the user, where the contacts have requested the user's digital profile information using the user's business card. The user's digital profile information may be shared with the contacts in the network of contacts.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a hybrid business card system that supports a social media environment for exchanging hybrid business cards in accordance with embodiments of the invention;

FIG. 2 is a schematic illustration of interactions between components of a hybrid business card system in accordance with embodiments of the invention;

FIG. 3 is a flowchart of a method for exchanging hybrid business cards in accordance with embodiments of the invention;

FIG. 4 is a schematic illustration of a management dashboard for monitoring hybrid business card providers and their leads in accordance with embodiments of the invention;

FIG. 5 is a schematic illustration of a management dashboards for generating a personal profile within a microsite linked to a hybrid business card in accordance with embodiments of the invention;

FIG. 6 is a schematic illustration of a management dashboards for generating a company profile within a microsite linked to a hybrid business card in accordance with embodiments of the invention;

FIG. 7 is a schematic illustration of a “landing” page of a hybrid business card microsite in accordance with embodiments of the invention;

FIG. 8 is a schematic illustration of a profile view of the hybrid business card microsite in accordance with embodiments of the invention;

FIG. 9 is a schematic illustration of a personal profile associated with the hybrid business card in accordance with embodiments of the invention;

FIG. 10 is a schematic illustration of a company profile associated with the hybrid business card in accordance with embodiments of the invention;

FIG. 11 is a schematic illustration of a contact webpage for a card recipient to share contact information with a card provider in accordance with embodiments of the invention;

FIGS. 12-16 are schematic illustrations of pages in a hybrid business card mobile application in accordance with embodiments of the invention, in which:

FIG. 12 shows a personal profile page linked to a hybrid business card;

FIG. 13 shows a company profile page linked to a hybrid business card;

FIG. 14 shows a real-time feed of activity linked to a user's hybrid business card;

FIG. 15 shows a statistics dashboard related to the user's hybrid business card;

FIG. 16 shows a contact map to visualize the geographic locations of a user's network of virtual contacts; and

FIG. 17 is a flowchart of a method for exchanging hybrid business card in a social media environment in accordance with embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” “generating,” “providing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In accordance with the present invention and as used herein, the following terms are defined with the following meanings, unless explicitly stated otherwise.

The term “physical business card” as used herein, is defined as a physical object that provides basic information about a company and/or an individual. The physical business card typically includes the card provider's name, company name, address, phone number, e-mail address, website, and fax number. Most commonly, a business card is distributed during introductions and professional meetings.

The term “hybrid business card” as used herein, is defined as a physical business card linked to a digital profile. Like a physical business card, a hybrid business card may be shared with others, for example, at business or social functions. However, the hybrid business card may also have printed thereon an encoded object (for example, a QR Code, or an augmented reality overlay) that may be used to access a website or dedicated microsite or webpage providing a virtual profile for the user. The encoded object may act as a “virtualization key” by providing a gateway to virtual profile content e.g. via the microsite. The microsite may be accessed by scanning the encoded object or by taking a photo of the card e.g. using a camera phone. Each physical card's microsite may be associated with the individual and/or company of the card provider.

A “hybrid business card provider” as used herein, is defined as a person, company or other entity named on a hybrid business card. The hybrid business card provider is also referred to herein as the “card provider,” “user,” “first user,” and “employee.”

A “hybrid business card recipient” as used herein, is defined as a person, company or other entity who receives and/or scans a hybrid business card. The hybrid business card recipient is also referred to herein as the “card recipient,” “lead,” “contact,” and “second user.”

A “hybrid business card system” as used herein, is defined as an infrastructure that supports a social media environment for exchanging hybrid business card. The hybrid business card system may include a computer system to generate online analytics, measurement, and social connectivity from the exchange of business cards and other offline printed media. The computer systems may include a content management, contacts management and analytics subsystems, related to the use of business cards and leads. The computer systems may include a mobile and web application for collecting and distributing business cards and other information related thereto. The hybrid business card system may provide a web dashboard for managing the content of the microsite, as well as a network of contacts or leads and analytics associated with the use of the hybrid business cards e.g. across an organization. The mobile application may allow a user to collect and share business cards and business related information with other users, while storing received information on the content and contacts management system, while the analytics system collects usage information about the shared contact and content information. The dashboard may allow a user to manage contacts, information related to the contacts and display said information to the user.

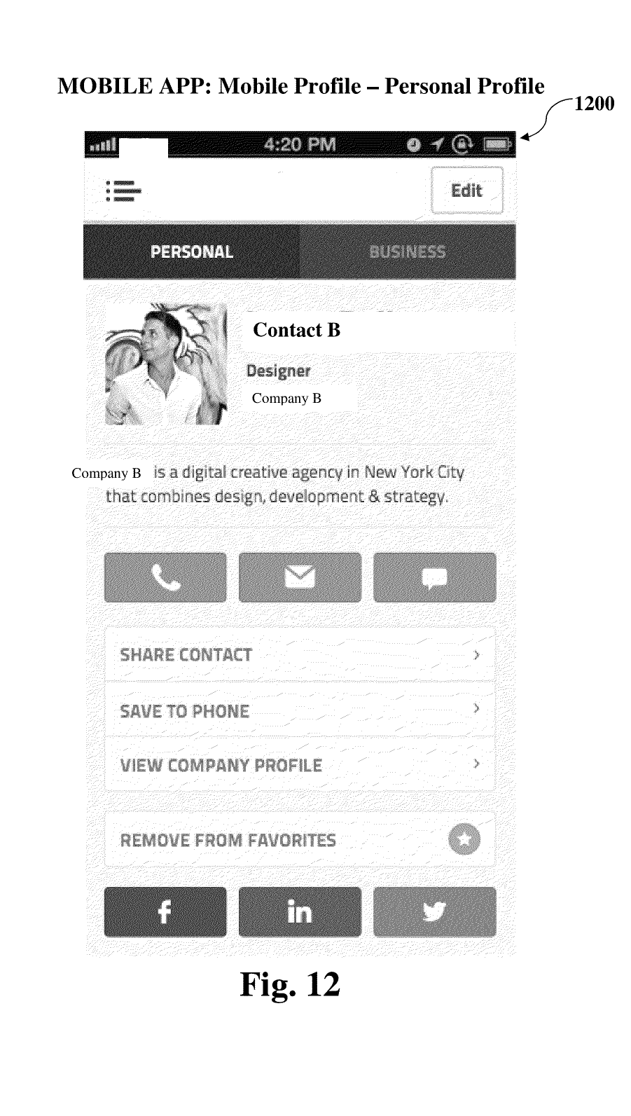

The hybrid business card system may also support a mobile application (e.g. see FIGS. 12-16). The mobile application may serve as a hub for all contacts that were collected by an individual and provides an additional level of information and lead generation to the physical card. The additional information may include company campaigns, notes about the generated lead, automatic notifications of profile updates, and mobile and web content.

The term “microsite” as used herein, is defined as a small cluster of one or more webpages. According to embodiments of the invention, a microsite may complement offline networking and marketing activity. A microsite is typically distinct from its parent website as it has a specific focus compared to the broader overall parent website. For example, a microsite may contain information about an event, promotion or product, which gives more relevant information targeted to the recipient than a website's general content. A company may create a separate, temporary microsite to inform contacts about a certain activity, event or product. A microsite may also be referred to as a “mobile profile.”

In some embodiments, each scanned hybrid business card may link to a single microsite associated with a card provider. Each card provider that has a microsite may also have a web “hub” or “portal” through which the card provider may access all information and all leads that were generated using the provider's hybrid business cards.

The term “management dashboard” as used herein may be a web-based application for managing content and/or monitoring analytics generated using the hybrid business card system. Individual users as well as company administrators (such as sales managers, marketing managers, etc.) may use the management dashboard to create or edit the content of user/employee microsites, monitor the online behavior of captured leads/contacts, and view system analytics. The analytics may be created from leads interacting with the user's hybrid business cards. An administrator may manage the lead information and may export the lead information using customer relationship management (CRM) software. In some embodiments, employees may access a limited version of the management dashboard to manage their own captured leads and view tracked results of lead behavior associated with the hybrid business cards they've distributed. Administrators may designate allowable fields to be populated by each employee, as well as manage the content of the company profile that appears in each employee's microsite. Administrators may view all data created by the employees of the company, including analytics and lead information generated using the distributed hybrid business cards.

Company administrators may be authorized, for example, using a password, encryption key or digital signature, to change the contents of the employee's microsite. The company profile of the microsite may be a dynamic marketing page with content changing in real-time, e.g., changed manually by the administrator or changed automatically triggered based on system analytics. For example, content may be changed automatically by a system server to be responsive to the browsing behavior of each individual lead, such as, pushing content related to buttons or links selected by the lead within the microsite. Content on an employee's microsite may also be determined based on the employee's geographic region/location, business division, or other criteria. Accordingly, the content of the microsite's company profile may be designated based on the specific needs of a particular group or category of employees. For example, content for employees in the organization's New York City office may differ from content for employees in that organization's London office. Likewise, an administrator may determine that special content may be relevant to a particular group of employees traveling to a networking conference. The company's administrator may be empowered with the ability to select what content leads who scan the cards of the employees are able to view.

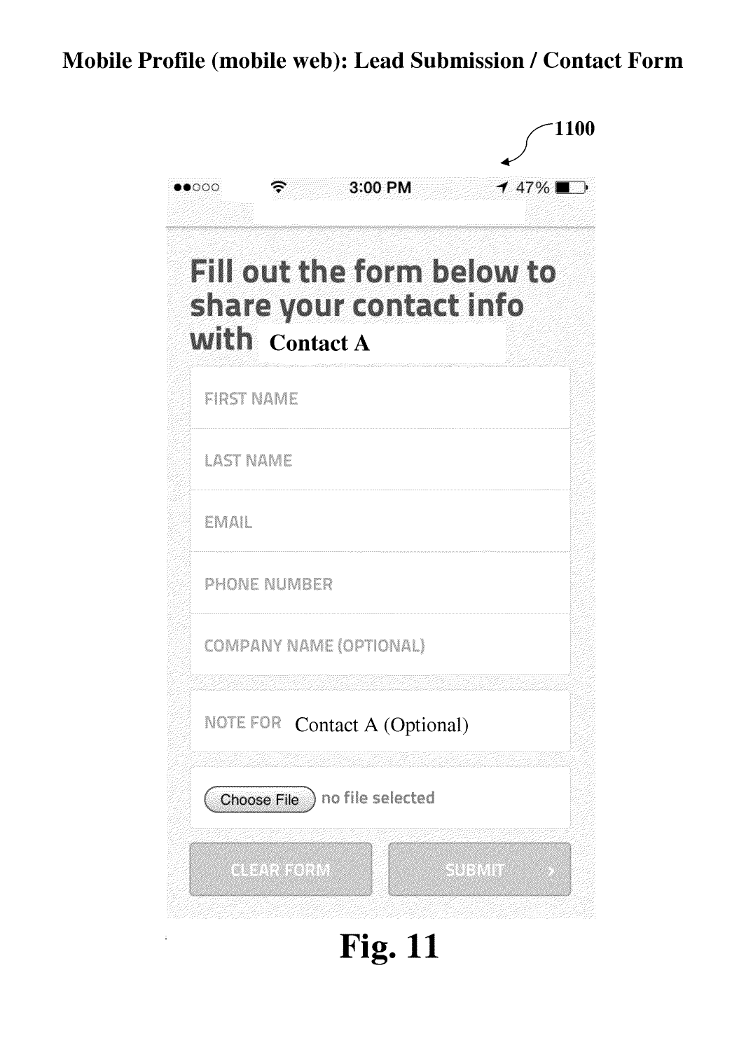

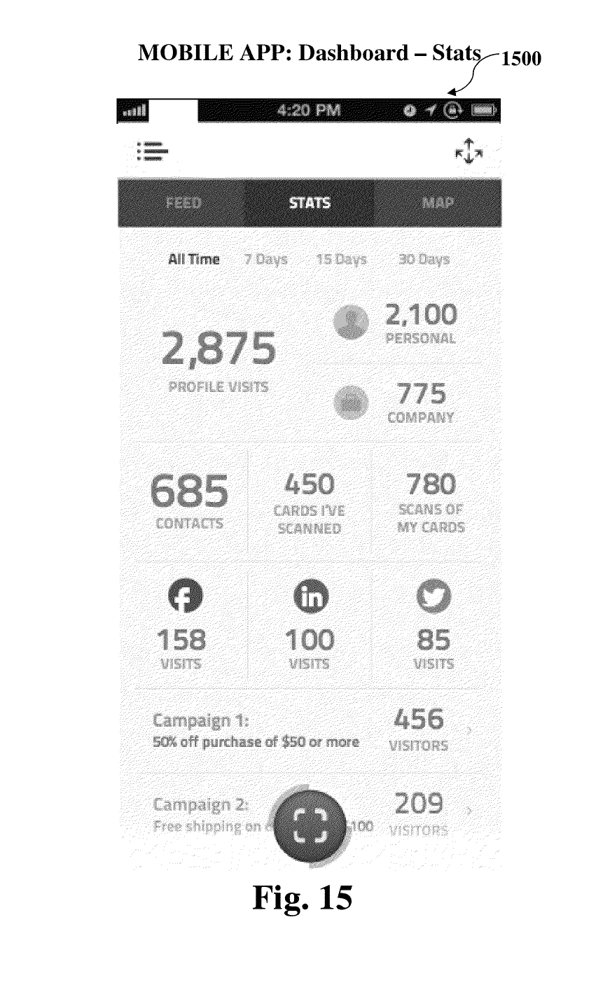

Analytics may be statistical information about the behavior of leads/contacts that is computed using recorded activities of the leads/contacts interacting with the hybrid business card and/or linked microsite. The system server in web applications or the local user device in mobile applications may record specific activities or interactions for a lead. Interactions may be recorded based on user's behavior and usage of the contact's mobile application, website or microsite. Each user action (e.g. scanning a business card, clicking a web object or navigating through a web path) may be recorded and sent to a system server to be stored and/or analyzed for example to generate lead statistics for that user. Recorded lead activities may include, for example, the location and time of a hybrid business card scan, the number of scans, unique scans, leads captured, which buttons a lead selects within the user's microsite, and capturing of the lead's contact information (e.g. a submission of the contact form shown in FIG. 11). The system server may use these recorded lead activities to automatically generate statistics, for example, the number of leads/contacts in the user's network of contacts, the number of cards the user has scanned, the number of scans of the user's hybrid business card, the number of visits to social media sites, the numbers of visitors of campaign pages, etc. (e.g. as shown in FIG. 15). The analytics may be viewed and utilized by an individual employee/user, by a company division or location, and/or by the organization as a whole. Analytics may be used as indicators of employee performance, e.g., indicating how effective an employee is in capturing leads and generating lead activity within a microsite. Companies may use the analytics data to incentivize employees with rewards programs or to measure employee networking performance.

Some embodiments of the invention may provide a dynamic map of connections and potential connections for contacts/leads, for example, generated in real time and on the fly. In some embodiments, an employee may authorize one or more other employees in a company or division to access their network of contacts to share potential clients or business leads. In one embodiment, an employee may use his/her web hub/portal to access information regarding his/her network of contacts. Once a contact/lead is added to the employee's network of contacts, information for the contact/lead may be stored associated with the employee's account and presented to the employee when he/she accesses the hub/portal or mobile application. The employee's network of contacts may be visualized by providing a graphical representation in which employees and leads (e.g., represented as nodes on a map or tree diagram) are connected by a link (e.g. represented as a visual edge or informational/non-visual data association connecting the nodes). If a lead is added by multiple employees, multiple links may be created connecting the employees together, through the lead. Each network of contacts may be unique to the company, division or employee.

Embodiments of the invention may provide a system and method that uses a hybrid business card, which may be a physical business card linked to a promotional and networking mobile website (e.g. microsite) of personal and/or company information. The system may provide a web dashboard for managing the content of the microsite, as well as the leads and analytics generated using the hybrid business card.

According to one embodiment of the invention, the hybrid business card may allow digital contact information (including, but not limited to, social media accounts and basic personal details) to be shared during a face-to-face networking opportunity. According to another embodiment of the invention, dynamic, relevant company content and information (including but not limited to, special offers, coupons, company news, promotions and media) may be delivered to prospective customers or contacts that scan the hybrid business card. According to another embodiment of the invention, contact information extracted or entered by card recipients may be sent to a web dashboard as a way to capture and manage leads. According to another embodiment of the invention, results of a lead's behavior within a microsite may be recorded and used to generate analytics that are sent to a web dashboard.

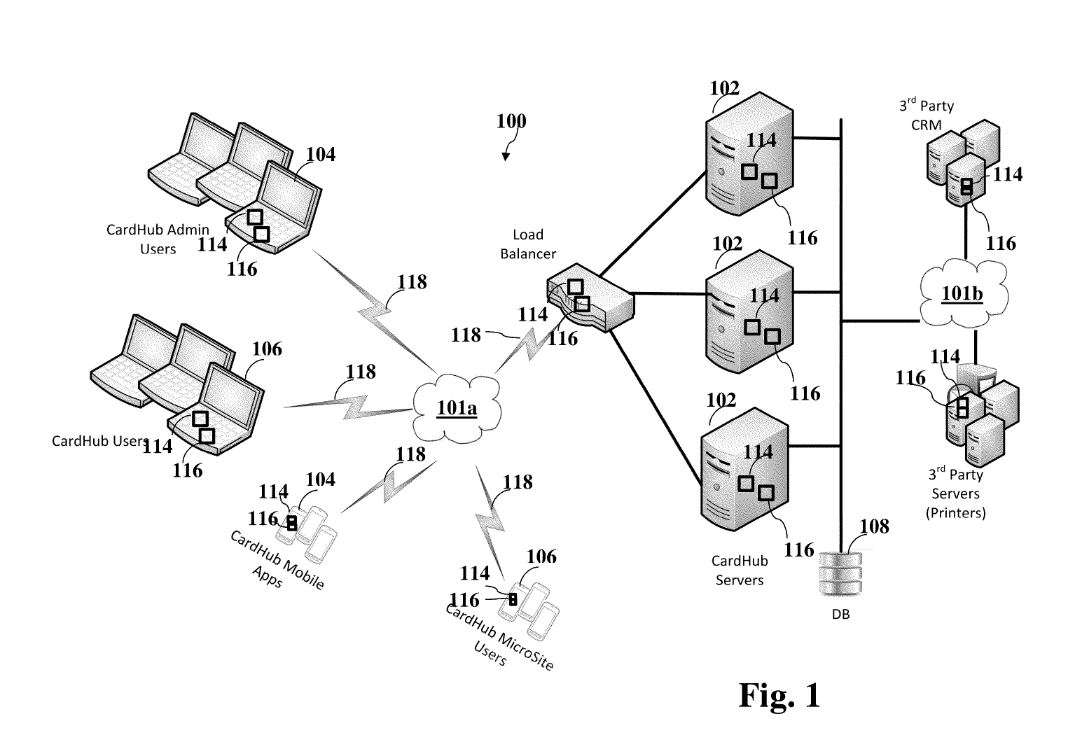

Reference is made to FIG. 1, which is a schematic illustration of a hybrid business card system 100 that supports a social media environment for exchanging hybrid business cards in accordance with embodiments of the invention.

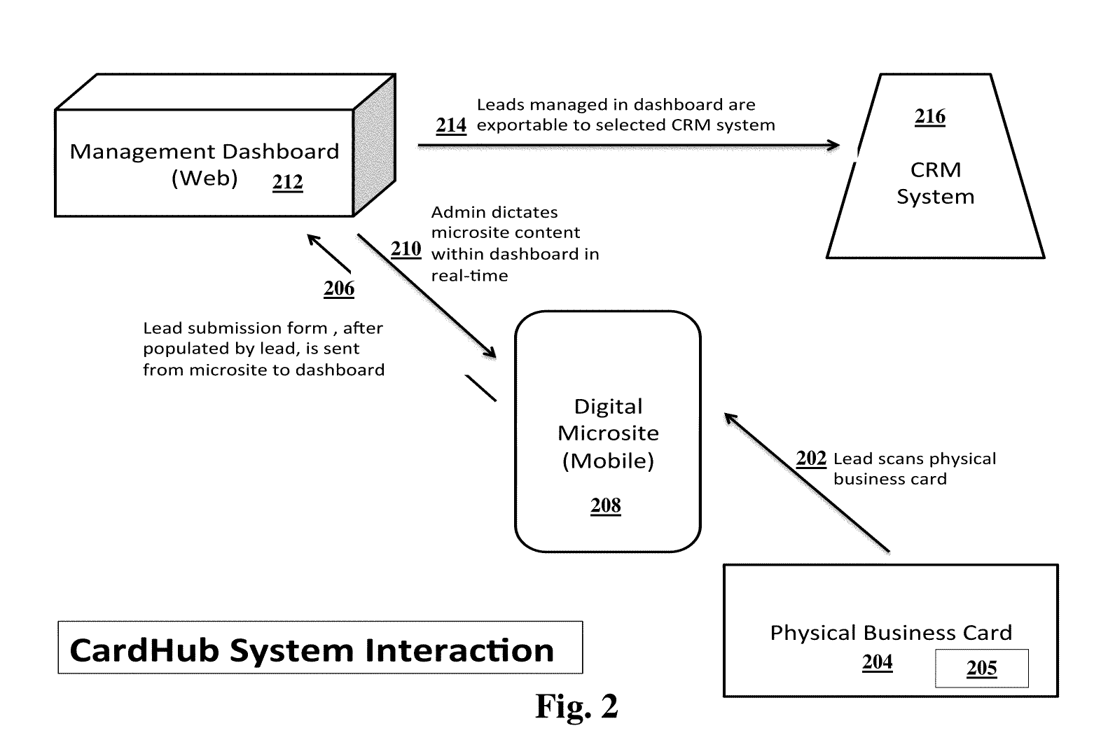

System 100 may include one or more system server(s) 102 for exchanging information using a hybrid business card. When more than one system server 102 is used, a load balancer 120 may distribute tasks therebetween. System server 102 may assign each user in system 100 a unique system code that uniquely identifies the user in system 100. The unique system code may be associated with a link 118 to the user's virtual profile website, microsite or mobile application. Link 118 may be e.g., an Internet address such as a url of the website, microsite or portal, an IP address e.g. of the profile hosting server, a username or other identifier of the website, microsite or mobile application account. System server 102 may encode the user's unique code and/or link 118 to generate an encoded object (e.g. encoded object 205 of FIG. 2). The hybrid business card may include a physical business card (e.g. physical business card 204 of FIG. 2) printed by printing servers 112 with the encoded object (e.g. encoded object 205 of FIG. 2) providing link 118 to a virtual profile for a first user (a hybrid business card provider) operating a first user device 104.

The hybrid business card may be distributed by the first user to a second user (a hybrid business card recipient) during a face-to-face meeting. The second user may scan or take a photograph of the encoded object printed on the first user's hybrid business card e.g. using a digital camera of a second user device 106. The second user device 106 may send a request over a communication network 101 to system server 102. The request may include information related to the encoded object associated with the first user, e.g., link 118 such as a url or the unique system code for the first user. In one embodiment, link 118 or the unique system code may be extracted or translated from the encoded object locally by second user device 106, e.g. using a decoding application or program therein, and sent to system server 102. In another embodiment, second user device 106 may send an image of the encoded object to system server 102 for system server 102 to translate or extract link 118 or the unique system code remotely. Extraction or translation may involve, for example, reading a code to produce link 118 to a website or microsite, or inputting the encoded object into a database the output of which is link 118. In one embodiment, the encoded object may inherently be link 118.

In response to receiving the request, system server 102 may retrieve a virtual profile for the first user from a database 108, e.g., using the user's link 118 and/or the unique system code extracted from the encoded object. For a website or microsite, second user device 106 may input the first user's link 118 as a url into a web browser to open the first user's microsite or webpage displaying content served from system server 102. For a mobile application, second user device 106 may download the first user's virtual profile data from system server 102 e.g. once for offline viewing, or periodically/when there is a notification push for online viewing. Database 108 may be a memory internal or external to system server 102.

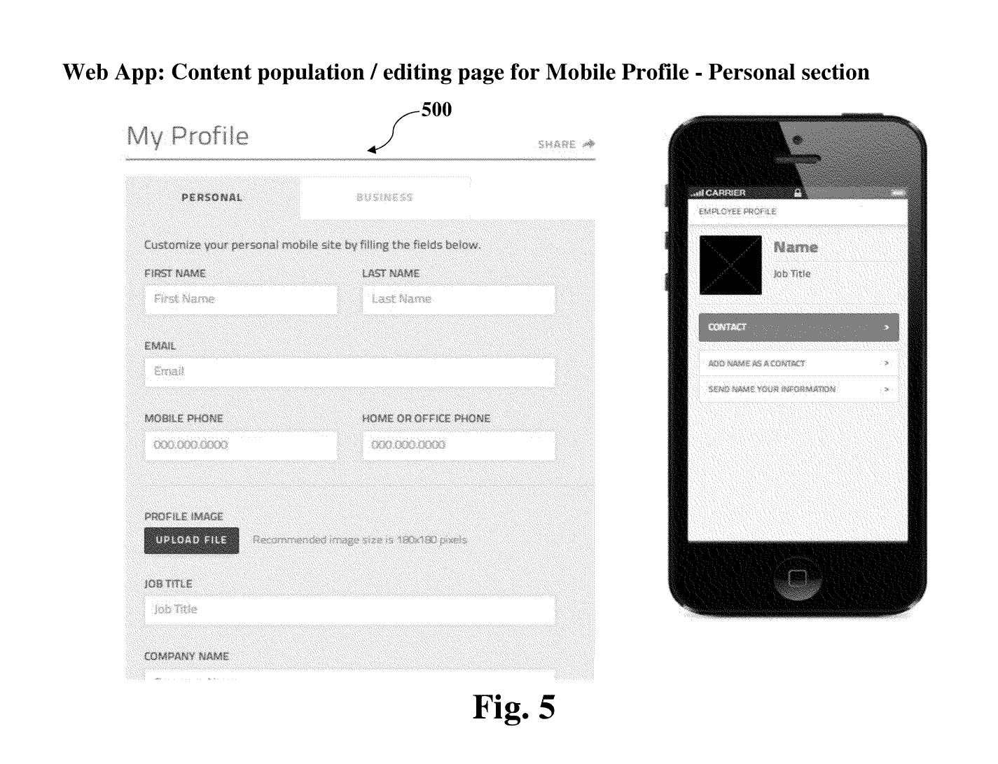

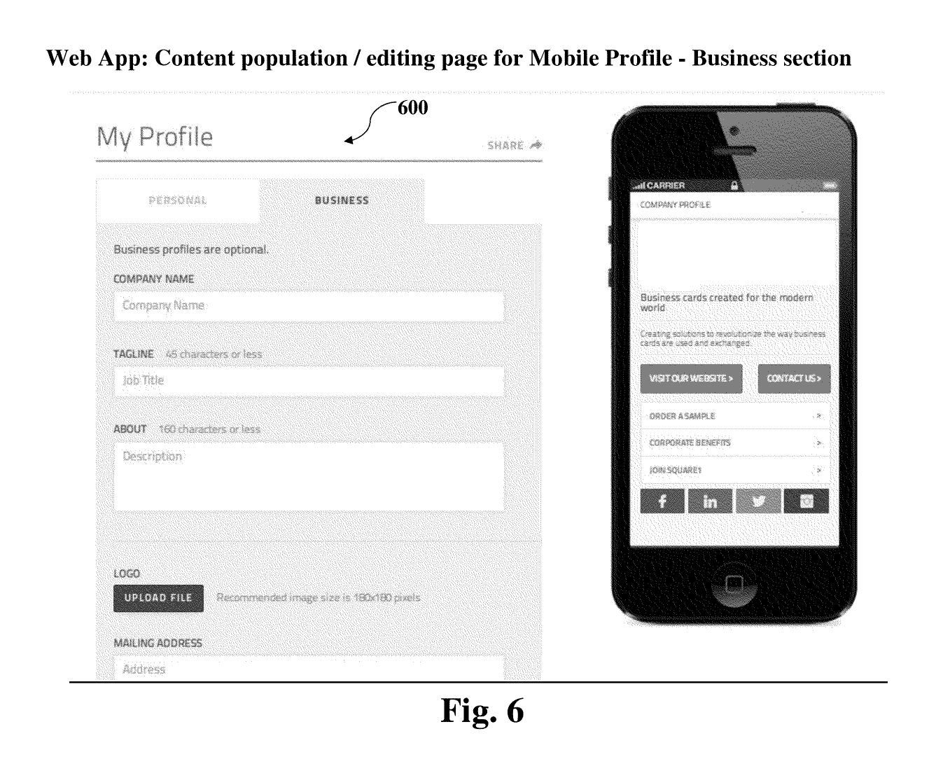

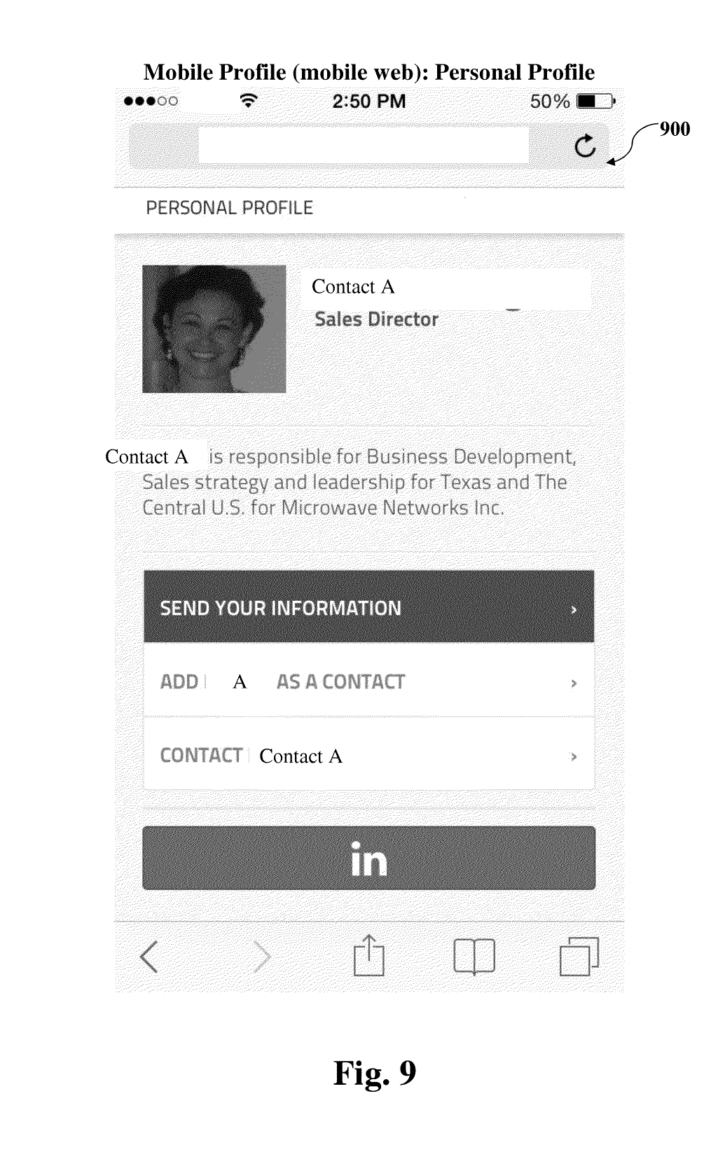

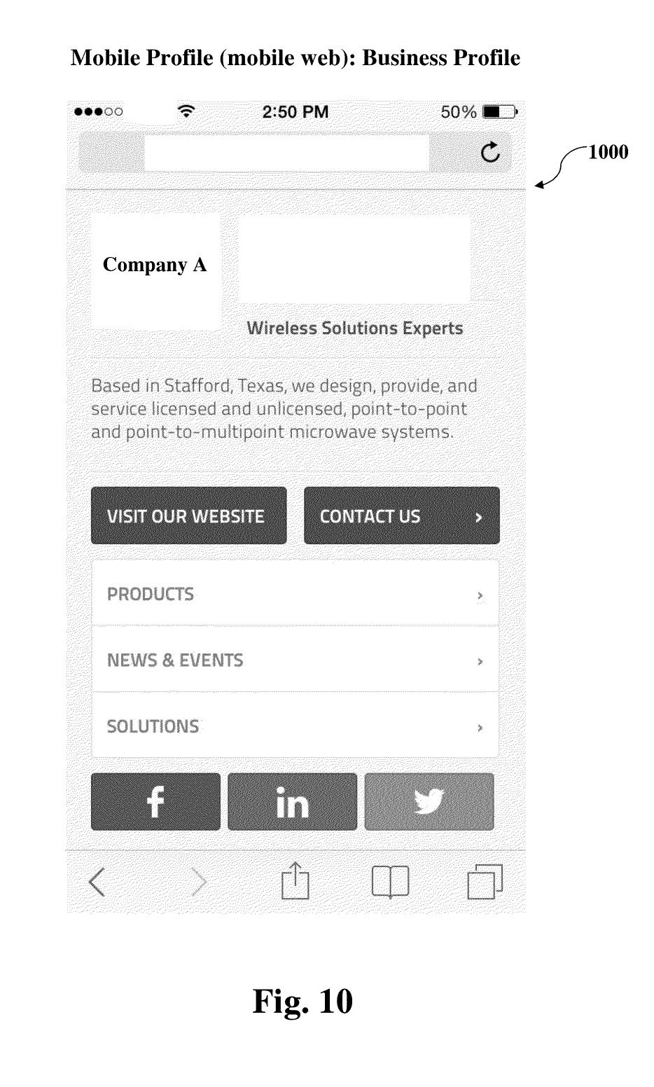

The virtual profile (e.g. as shown profiles 900 and 1000 of FIGS. 9 and 10) may include personal and/or company information (e.g. as shown in FIGS. 5 and 6). The first user may create a virtual profile using server 102. The first user's virtual profile may be a one or more pages in a microsite, website or mobile application. Virtual profiles may be stored in remote database 108 or in local memories 116 of user devices 104 and/or 106.

In order to access (e.g., view, navigate within a website, etc.) the first user's virtual profile, the second user may be required to (or may optionally) share personal and/or company contact information by creating a second user virtual profile (e.g. as shown in FIG. 11), or, if the second user has already created such a virtual profile, by logging into the second user's account and sharing that profile with the first user. In this way, the first and second user may reciprocally exchange information and be linked as contacts. Digital information, such as virtual profiles, may be transferred between devices using for example e-mail, text messaging, NFC, and/or augmented reality over communication network 101 such as the Internet. System server 102 may send the second user's information to a CRM server 110, which may be the same or separate from server 102. CRM server 110 may manage the second user's information, for example, and may associate the second user's information with the first user's identity or virtual profile, so that first and second users are contacts. In some embodiments, CRM server 110 may also provide the second user's information to other company employees, connect the second user to a specific account, etc. In some embodiments, CRM server 110 may also store contact related information for functionalities such as sales support, marketing and usage statistics. Storing contact information on CRM server 110 may automatically allow for immediate access to the contact information by the organization using the CRM.

Once the first and second users are contacts, system server 102 may monitor/record second user device 106 activity or interactions and report such activity to the first user. Recorded behavior may include, for example, where and when second user device 106 scanned the first user's hybrid business card (e.g. by downloading gps coordinates of the requesting device), content viewed or selected by second user device 106, such as, a time log of links or pages viewed within the first user's microsite or mobile application, statistics or web analytics of second user device 106, such as, how long the second user viewed the first user's virtual profile, data downloaded therefrom, if the second user shared the first user's contact with a third user.

System server 102 may also track each time the first user's virtual profile file is forwarded to a new lead, e.g., using a timestamp for the activity, and send a report or notification to first user device 104. Each new lead to which the first user's virtual profile file is forwarded in a chain of leads may be added to the first user's network of contacts. The chain of leads may be compiled and reported to first user device 104, for example, as an ordered list of the leads in the chain, or as a connection tree graph or map with nodes for each new lead and/or edges indicating pairs of leads that have shared the first user's virtual profile. The first user may use the list or map to identify which leads actively share its contact information.

First and second user devices 104 and 106 may include computing devices, such as, personal computers, laptop computers, desktop computers, mobile devices, cell phones, smart phones, camera phones, tablets or any devices with the able to communicate with system server 102.

Servers 102, 110 and 112 and user devices 104 and 106 may each include one or more processor(s) 114 to execute logic and/or instructions to implement operations according to embodiments of the present invention and one or more memor(ies) 116 to store the logic and/or instructions, as well as input to, output from and/or intermediary results generated according to embodiments of the present invention. Processor(s) 114 or other units such as server 102 or user devices 104 and 106 may be configured to perform methods according to embodiments of the present invention by, for example, being coupled to (or in the case of a server or user device, including) memory 116 storing software or instructions which when executed cause processor 114 to carry out embodiments of the present invention. In various embodiments, processor 114 may be a general purpose computer processor or central processing unit executing software, digital signal processors (DSPs) or dedicated chip, or other circuitry.

Network 101, which connects servers 102, 110 and 112 and user devices 104 and 106, may be any one or more publicly accessible network such as the Internet. Access to network 101 may be through wire line, terrestrial wireless, satellite and/or other systems well known in the art.

Reference is made to FIG. 2, which is a schematic illustration of interactions between components of a hybrid business card system, e.g., system 100 of FIG. 1, in accordance with embodiments of the invention.

In interaction 202, a lead or hybrid business card recipient may scan an encoded object 205 on a physical business card 204, for example, using a lead device equipped with a camera or scanner (such as, second user device 106 of FIG. 1). The lead device may send a request including scanned data to a system server (e.g. system server 102 of FIG. 1) for information related to the hybrid business card.

In interaction 206, the system server may receive contact information from the lead device (e.g., by the lead entering information in device 106, or system server 102 automatically providing lead contact information) and, in response, the system server may send the lead device the virtual profile of the card provider via a digital microsite e.g. in a mobile application 208.

In interaction 210, an authorized user (e.g., an administrator or the card provider) may use management dashboard 212 to create and edit the content of the card provider's virtual profile, for example, in real-time or as it is being viewed on the lead device.

In interaction 214, the information collected in operation 206 for each lead may be exported or transmitted to a CRM system 216 (e.g. CRM server 110 of FIG. 1).

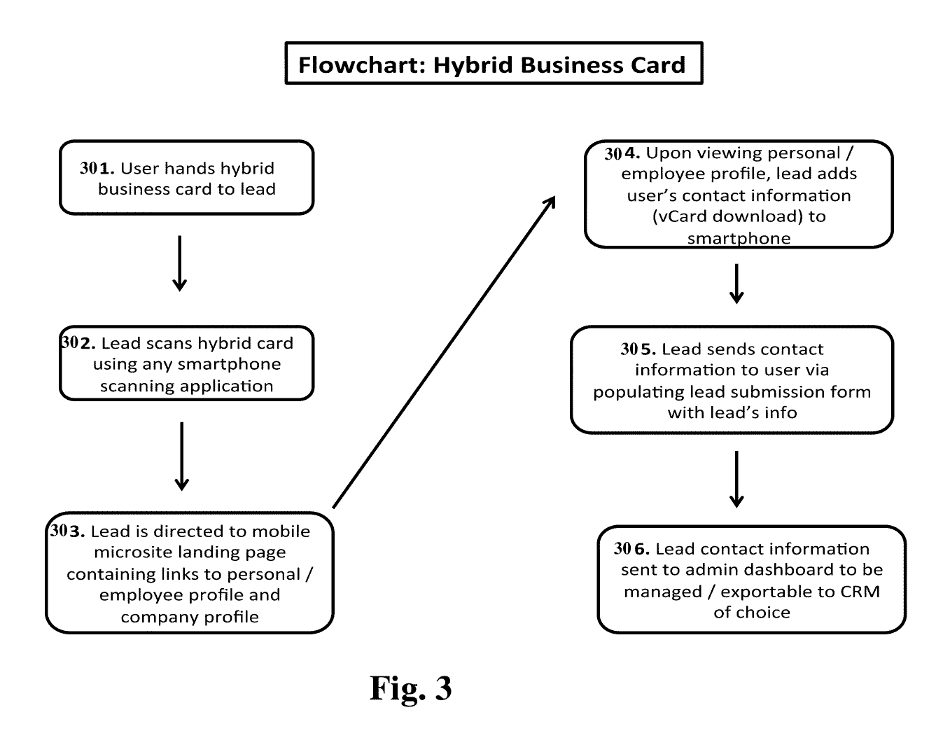

Reference is made to FIG. 3, which is a flowchart of a method for exchanging hybrid business cards in accordance with embodiments of the invention. The embodiment of FIG. 3 may be executed using components of a hybrid business card system, such as, system 100 of FIG. 1.

In operation 301, a user or card provider may distribute a hybrid business card to a lead. The hybrid business card may be distributed offline as a physical object during an in-person meeting or may be distributed online as a virtual business card (e.g. shared via e-mail). The hybrid business card may have an encoded object printed thereon. The encoded object may be assigned to the user during a user registration process. During the registration process, a system server (e.g. system server 112 of FIG. 1) may assign a unique code to the user that uniquely identifies the user in system 100. The information provided by the user during registration may be stored on the server side (e.g. in database 108 of FIG. 1). The same unique code may be used by the system server for generating a link (e.g. link 118), that, in turn is encoded into the encoded object and printed (e.g. by printing server 112 of FIG. 1) onto the user's hybrid business cards.

In operation 302, a server (e.g. system server 102 of FIG. 1) may receive a request from the lead scanning the encoded object on hybrid business card (e.g. using second user device 106 of FIG. 1). The encoded object may be decoded locally at the lead device (e.g. second user device 106 of FIG. 1) or sent to the system server (e.g. system server 112 of FIG. 1) to extract the link encoded therein. Each link may be unique to a user (no two users are assigned the same link).

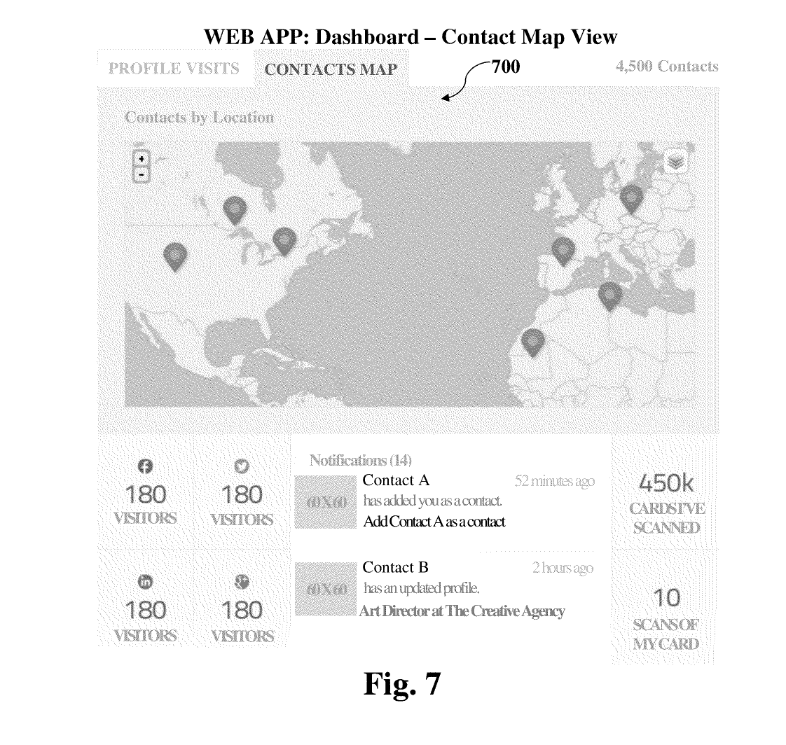

In operation 303, the server may use the link to direct the lead to the card provider's virtual profile. The link includes the user's unique pre-assigned registration code, which is used to identify and direct the lead to the user's unique virtual profile website, microsite or mobile application page(s). The website or microsite may be supported by system server 102 or a third party website or mobile application hosting server. The server or a local mobile application on the lead's device may send the lead to a landing page (e.g. landing page 700 of FIG. 7). The landing page may provide links to a personal profile page (FIG. 9) or a company profile page (FIG. 10) of the user's virtual profile. The virtual profile may provide the lead with, for example, the following information:
i. Personal Profile:
   1. Personal contact information
   2. Social Links
   3. Custom buttons (e.g. links to user's videos, etc.)
ii. Company/Business Profile:
   1. Business information (e.g. company name, description, address)
   2. Social links (e.g. company's social media pages)
   3. Custom buttons/campaigns (e.g. the company's latest offering, product or service)
      Other information may be provided. The virtual profile information may be retrieved using the system server from secure storage in the server's database (e.g. database 108 of FIG. 1).

In operation 304, upon viewing the personal and/or company profile page, the server may receive a request from the lead to add the card provider's personal or company contact information to the contact list stored locally in the lead device. In response, the server may retrieve the requested contact information from a contact database (e.g. database 108 of FIG. 1) as a contact file and send the contact file to the lead's device in a format compatible with the device so that it may be integrated into the local device contact list.

In operation 305, the server may receive contact information entered by the lead populating a lead submission form (e.g. FIG. 11), by signing into an account in which the lead's contact information is already saved, or via another method. To register the lead, the server may provide the lead with the submission form or another data entry portal, through which the lead's information may be uploaded to the server and then to the database (e.g. database 108 of FIG. 1). The server may capture or record the lead's location and/or time of registration and send this information, e.g., via a secure connection, to the server for future analytics. In turn, the server may store the information in database 108 for future use. The server may assign the lead a unique user identity code and add the lead to the user's list of leads. Accordingly, next time the user accesses the system, the lead's information may be automatically available to the user from the database via the server. A notification may be sent from the server to notify the user that he/she is connected to a new lead. Once connected as contacts, the user and the lead may communicate using their shared contact information.

In operation 306, the server may receive and send the lead's contact information to an administrator dashboard to be managed or exported using CRM software (e.g. at CRM server 110 of FIG. 1).

Other operations or orders of operations may be used.

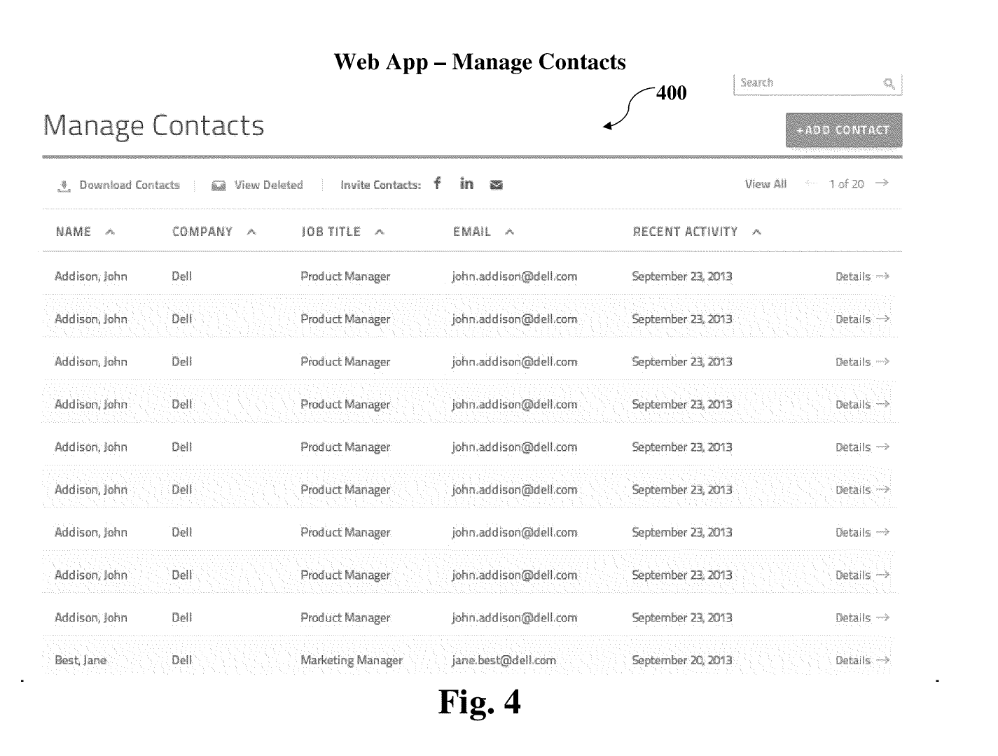

FIGS. 4-16 show digital content pages provided in different formats, such as, a microsite or web application (FIGS. 4-8), a mobile web application (FIGS. 9-11) and a mobile application (FIGS. 12-16), although these web formats are interchangeable and the pages of the microsite may be provided via any of these or other web formats.

Reference is made to FIG. 4, which schematically illustrates a management dashboard 400 for monitoring hybrid business card providers and their leads in accordance with embodiments of the invention. Management dashboard 400 may provide a log of activities or interactions associated with one or more associated hybrid business cards identified by the card provider's name, company, job title, contact information such as e-mail address, the date/time of activity and the details of the activity. The interactions may be for example with server 102 or a third party server. Activities or interactions may include the hybrid business card being scanned by a lead, forwarded to another user, the lead sharing its own contact information with the card provider, the lead accessing the server for information related to the card provider, the lead looking up websites linked to by the card provider or associated with the hybrid business card, etc. The log may be sorted based on card provider name, number of leads generated, location, and/or job title. Statistics related to hybrid business card activities may be automatically computed and reported to the hybrid business card provider or administrator, for example, via the statistics management dashboard shown in FIG. 15.

Reference is made to FIGS. 5 and 6, which are schematic illustrations of management dashboards 500 and 600 for generating a personal profile and a company profile, respectively, within a microsite linked to a hybrid business card in accordance with embodiments of the invention. Management dashboards 500 and 600 may be supported by server 102 when provided by a web application and/or by local user devices 104 and/or 106 when provided by a mobile application.

In FIG. 5, a hybrid business card provider (e.g., the person named on the hybrid business card) may enter personal information into management dashboard 500 that is unique or custom to the card provider, such as, name, e-mail address, telephone number(s), profile image, etc.

In FIG. 6, the hybrid business card provider or another authorized user, such as, a company administrator, may enter company or business information into management dashboard 600, such as, company name, job title, company description or tagline, company logo, company mailing address, a link to the company website, etc.

The hybrid business card provider may initiate entering content into management dashboards 500 and 600 or may be prompted e.g. by receiving an e-mail message granting access, e.g., providing a secured or unsecured link, to a webpage displaying dashboards 500 and 600.

Once the hybrid business card provider's virtual profile is generated, the provider may share hybrid business cards with leads. The leads may use a mobile phone scanner to scan an encoded object printed on the hybrid business cards to access the hybrid business card provider's virtual profile in a microsite.

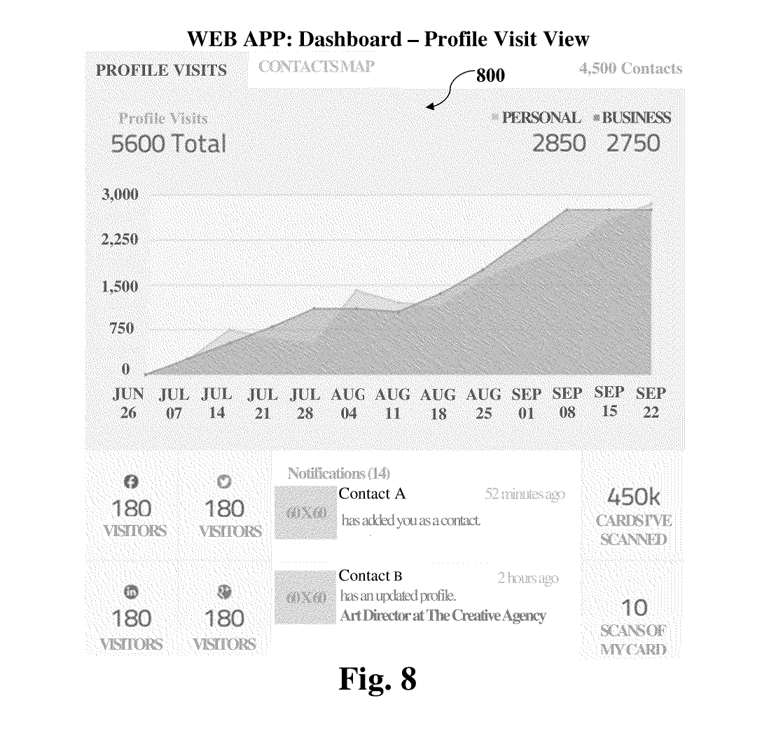

Reference is made to FIG. 7, which schematically illustrates a “landing” or home page 700 of a hybrid business card microsite in accordance with embodiments of the invention. Once a hybrid business card is scanned, the card recipient may automatically be directed to landing page 700. Landing page 700 may include a company logo, a button or field to access the provider's personal profile and a button or field to access the provider's company profile. Landing page 700 may include a contact map view (an example of which is shown in FIG. 7) and/or a profile view (shown in FIG. 8). In the contact map view shown in FIG. 7, a contact map may visualize the geographic location of each of the provider's network of virtual contacts (e.g. the contact's location of residence, business or where the contact scanned the provider's card). Recording the locations where each card is scanned may provide a visualization of the “geographical density” and effectiveness of distributing cards at different locations. For example, for employees that attend a conference and distribute cards, the contact map may provide a visualization of where the cards were distributed, used and scanned to see which employee was more effective, which information was uploaded, etc. Landing page 700 and other pages may be customized for each provider microsite or company hub, for example, using one of a plurality of templates.

Reference is made to FIG. 8, which schematically illustrates a profile view 800 of the hybrid business card microsite in accordance with embodiments of the invention. Profile view 800 may provide hybrid business card statistics, such as a number of cards the provider has scanned and the number of recipient's who have scanned the provider's card and provide access to (e.g., allow viewing of) a “personal profile” shown in FIG. 9 or a “company profile” shown in FIG. 10, respectively. In some embodiments, “providing access to” a profile or other information may mean providing a quick and easy link to that information provided online via a website. In some embodiments, providing access to a profile or other information may not be restricted access, and users who have not accessed the information via a hybrid business card, or a link or business card according to embodiments of the present invention, may access the information as well.

Reference is made to FIGS. 9 and 10, which schematically illustrate a personal profile 900 and a business/company profile 1000, respectively, associated with the hybrid business card in accordance with embodiments of the invention.

In personal profile 900 in FIG. 9, the card recipient may access the card provider's contact information e.g. created using management dashboard 500. Personal profile 900 may include the card provider's name, company, job title, image and contact information. The recipient of the hybrid business card may import the provider's contact information to his/her mobile device as a new contact e.g. by selecting a “add provider as a contact” button. The card recipient may connect to the card provider online, for example, via text, e-mail or social networks e.g. by selecting a “contact provider” button. The recipient may also send his or her own personal contact information to the individual whose hybrid business card he/she scanned e.g. by selecting a “send your information” button. Selecting the “send your information” button may open a lead submission form webpage (e.g. shown in FIG. 11) allowing the lead or card recipient to populate the contact information fields and submit the form as a contact file to the hybrid business card provider.

In company profile 1000 in FIG. 10, the card recipient may access relevant content and information e.g. created by the provider or a company administrator using management dashboard 600. Company profile 1000 may include customized “campaign” buttons (e.g., products, news and events, and solutions) whose function and purpose may be changed at any time from management dashboard 600. Company profile 1000 may also include the company's logo, social links, tagline, brief description, website link, and contact information. This company content may be dynamically updated e.g., manually by the company administrator or automatically triggered based on system analytics.

The account administrator may change links and related information for the company profile within the microsite e.g. from management dashboard 600. The employee/user may change the content of the microsite's personal profile, e.g. from management dashboard 500 of FIG. 5, limited by the permissions granted by the company administrator. In some cases, administrators may not grant any permission to the employee and the employees may not make any changes to the content. Each employee may be assigned unique or individual permissions via unique login credentials or authorization code allowing the employee to view their hybrid business card account and edit the content.

Reference is made to FIG. 11, which schematically illustrates a contact webpage 1100 for a card recipient to share contact information with a card provider in accordance with embodiments of the invention. Contact webpage 1100 may include a contact form consisting of multiple fields of contact information including name, e-mail address, and telephone number, etc. The lead may also submit an optional note or message to the hybrid card provider, as well as an optional file or photograph. If the card recipient has already created a submission form (FIG. 11) or a virtual profile as a card provider (FIG. 5), the card recipient may access and send the saved contact information e.g. by logging in to the recipient's account.

Reference is made to FIGS. 12-16, which schematically illustrate pages of a hybrid business card mobile application in accordance with embodiments of the invention. The mobile application may be downloaded from a system server (e.g. system server 102 of FIG. 1) and executed locally on the user devices (e.g. user devices 104 and/or 106 of FIG. 1).

Using the mobile application, in response to the hybrid business card recipient scanning the encoded object on the physical business card or receiving a virtual business card (e.g. via NFC, text etc.), the system server may automatically direct the recipient to a webpage to download the mobile application or the mobile application may automatically open if it has already been downloaded. Once downloaded, the mobile application may store the provider's contact information associated with the scanned hybrid business card. The provider's contact information may be available immediately via the mobile application, online and/or offline.

Unlike a microsite, which may be linked to a single hybrid business card, the mobile application may provide a recipient with access to all virtual profiles associates with all their collected hybrid business cards. Accordingly, the mobile application stores information for all of a user's plurality of contacts in the same place, whereas each microsite may provide information for one of the user's contacts.

Using the mobile application, notification updates representing changes in content, such as, new marketing information or promotions made available by different companies, may be sent to card recipients who scanned hybrid business cards of employees of those companies.

The mobile application may allow users to share business card related information with each other through different digital communication platforms such as e-mail, text, NFC, and augmented reality. Accordingly, the mobile application may allow users to share contact information without scanning a physical business card, or, obtained indirectly from others scanning a physical business card.

The mobile application may be compatible with all mobile operating systems (e.g. Android, iOS, Win, etc.).

In FIG. 12, the mobile application provides a personal profile page 1200 linked to a hybrid business card. Personal profile page 1200 may provide similar functionality to web personal profile 900 of FIG. 9 in a mobile application.

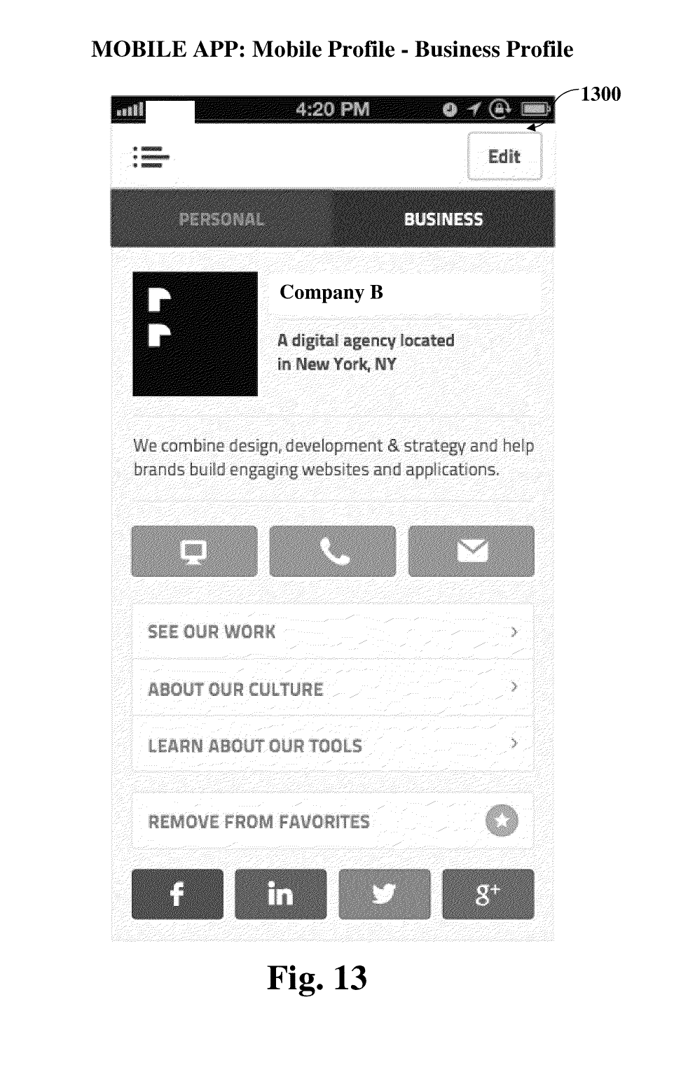

In FIG. 13, the mobile application provides a company profile page 1300 linked to a hybrid business card. Company profile page 1300 may provide similar functionality to web company profile 1000 of FIG. 10 in a mobile application.

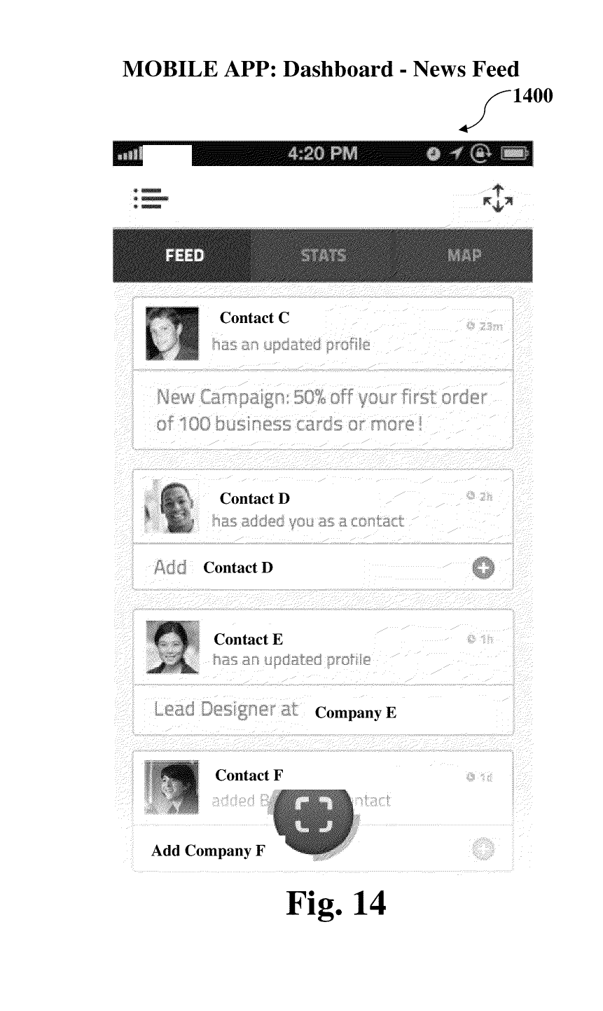

In FIG. 14, the mobile application provides a real-time feed 1400 of activity linked to a user's hybrid business card. Activities or interactions may include the user's hybrid business card being scanned by a lead, forwarded to another user, the lead sharing its own contact information with the user, a contact being added or deleted from the user's network of contacts, a lead adding or deleting the user from the lead's network of contacts, a contact updating their personal or company profile.

In FIG. 15, the mobile application provides a statistics dashboard 1500 related to the user's hybrid business card. Statistics may include the number of leads that visited the user's profile page (FIG. 12) and/or company page (FIG. 13), the number of contacts in the user's network of contacts, the number of cards the user has scanned, the number of scans of the user's hybrid business card, the number of visits to social media sites, the numbers of visitors of campaign pages.

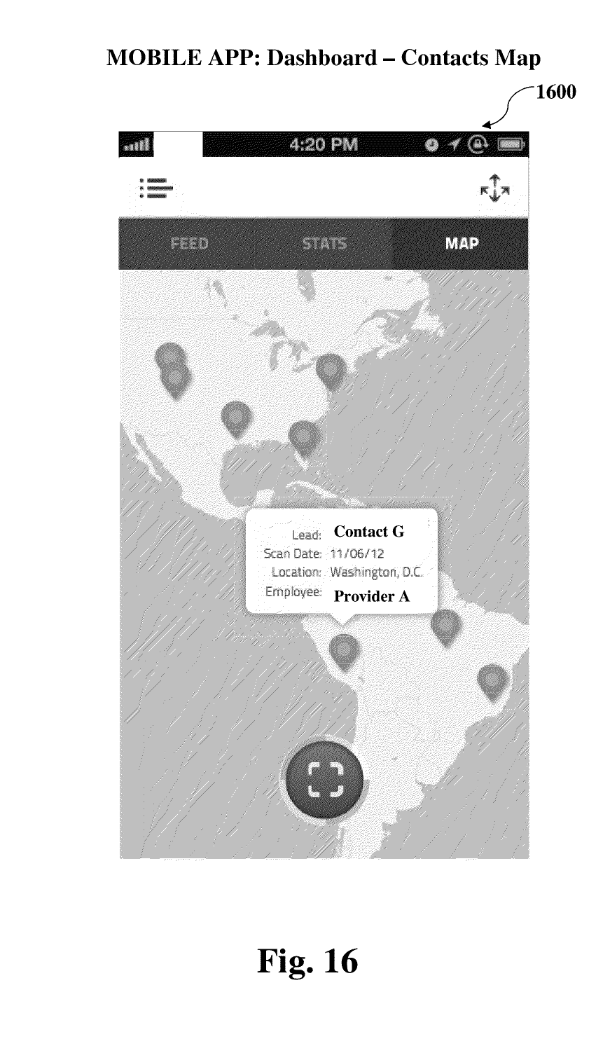

In FIG. 16, the mobile application provides a contact map 1600 to visualize the geographic locations of a user's network of virtual contacts. Contact map 1600 may provide similar functionality as the contact map shown in landing page 700 of FIG. 7 of FIG. 10 in a mobile application. Contact maps may include information other than shown in FIG. 7.

Other mobile application pages or functionality may be used.

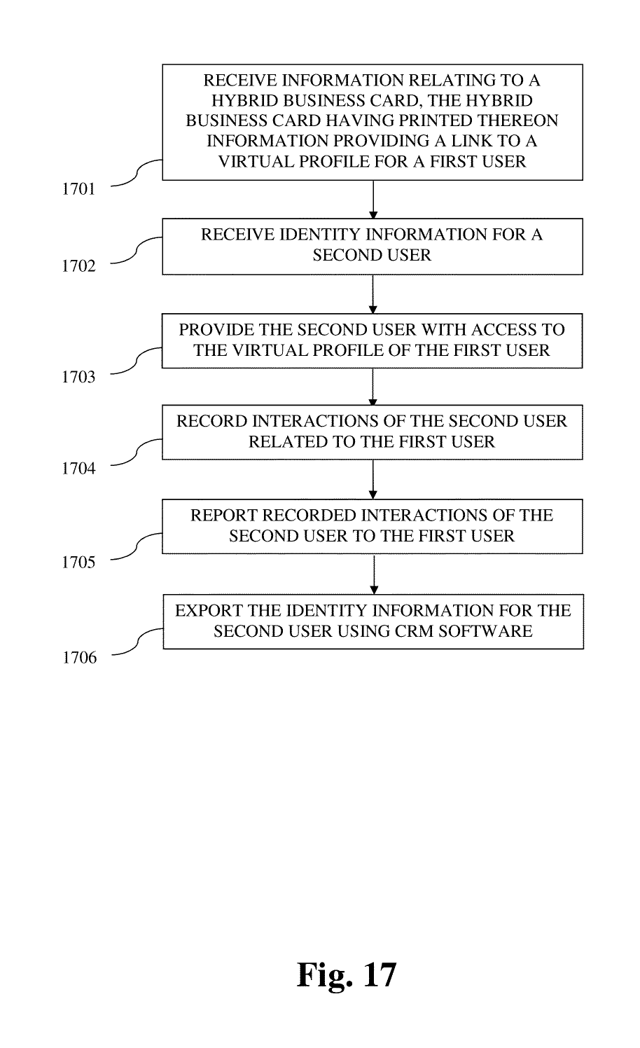

Reference is made to FIG. 17, which is a flowchart of a method for exchanging hybrid business card in a social media environment in accordance with embodiments of the invention. The method of FIG. 17 may be executed using a hybrid business card system, such as, system 100 of FIG. 1.

In operation 1701, a remote server (e.g. system server 102 of FIG. 1) or a local device (e.g. second user device 106 of FIG. 1) operating a mobile application may receive information relating to a hybrid business card for a first user. The information may be a request received from a device of a second user (e.g. second user device 106 of FIG. 1) scanning information, such as, an encoded object, that is printed on the hybrid business card and that provides a link to a virtual profile for the first user.

In operation 1702, the server or local device may receive identity information for the second user. The identity information may be provided by the second user automatically in the request or via contact form 1100 in FIG. 11. Identity information may include second user device information such as an IP address or other device identifier, or information personal or unique to the second user such as a name, username, telephone number, etc. The second user's identity information may be associated with the information related to the hybrid business card, for example, being sent in the same or sequential request(s) or being sent in a request identifying the first user.

In operation 1703, in response to receiving the information relating to the hybrid business card, the server or local device may provide the second user with access to the virtual profile of the first user. The server or local device may retrieve the virtual profile from a memory (e.g., remote memory 108 or memory 116 internal respectively thereto). The virtual profile may include information relating to the first user (e.g. personal profile 900 information shown in FIG. 9) and/or to an organization associated with the first user (e.g. company profile 1000 information shown in FIG. 10). The virtual profile information may be created using management dashboards 500 and/or 600 in FIGS. 5 and 6.

In operation 1704, the server or local device may record (e.g. capture, log and/or save to database 108) activities or interactions of the second user related to the first user. Activities or interactions may include receiving information relating to a hybrid business card for a first user, forwarding the first user's virtual profile, receiving identity information for the second user, the second user being added or deleted from the first user's network of contacts, the second user adding or deleting the first user from its network of contacts, the first or second users updating their virtual profile.

In operation 1705, the server or local device may report the recorded interactions of the second user to the first user. The second user's recorded interactions, e.g., along with interactions from multiple other second users or “contacts,” may be analyzed automatically by the server or local device and reported to the first user as statistics in statistics dashboard (e.g., statistics dashboard 1500 of FIG. 15).

In operation 1706, the server or local device may export the identity information for the second user to a CRM server (e.g. CRM server 110 of FIG. 1). Once the CRM server receives the second user's information, the information may be stored in the CRM server (e.g. in its DB/internal memory 116 shown in FIG. 1), and may be associated with the first user. Further, the CRM server (e.g. based on its configuration) may provide the second user's information to other company employees, connect the second user to a specific account, etc.

Other operations or orders of operations may be used.

The hybrid business card may have a dual purpose, for example, to be used as both a networking tool (providing contact information) and a marketing tool (providing promotions, such as coupons, exclusive media, time-based offers, etc.) for card recipients. Likewise, the hybrid business card allows the card recipients to access a complete social networking experience (such as that provided by online social media networks) while offline.

Each business and its respective prospects/clients have specific needs or interests. The hybrid business card is versatile enough to be used in any circumstance in which a traditional business card would be deployed, while adding a second dimension: an online connection. The hybrid business card recipient/lead need not take any action (i.e. scanning the encoded object) and can simply treat the hybrid business card as a traditional, physical business card. Once the encoded object on the physical business card is scanned, however, a complementary virtual business card is downloaded onto the scanning device. The virtual business card includes the card provider's digital contact information that may be uploaded into the recipient's contact list. The virtual business card may also include a link to the card provider's personal and/or company microsite.

Card providers may review the behavior and actions taken by leads who have received their hybrid business cards via scan tracking and other generated analytics. The analytics produced from the hybrid business card scans provide time, location, and date of the scans, along with other related information that the card recipient/lead has chosen to provide, including contact information, a note, a photograph, etc.

User behavior of both card provider and card recipients/leads may be recorded through the user's usage of another user's mobile application, microsite or web application. To track mobile application usage, user information may be recorded using the user's mobile device (e.g. user devices 104 or 106 of FIG. 1) as the user navigates through different pages or windows or uses different functionalities of the application. To track the user's web application usage, the web application may be configured to record user actions. Each user action (e.g. scanning a business card, clicking a web object or navigating through a sequence of web pages) is recorded and sent to a system server and stored in the system database. Each user action report may capture the time, location and type of the operation.

User information may be analyzed, for example, by an analytics server, which may be the same or separate from the system server(s) (e.g. server 110 of FIG. 1). An application programming interface (API) may be used to integrate the local and server systems, for example, to retrieve or funnel user information from the user devices to the analytics server, e.g. top compile usage information, and back from the analytics server to the user devices, e.g. to report of statistics for user usage information. The analyzed user information may be presented as statistics (e.g. see statistics dashboard in FIG. 15).

User information may be analyzed and used in different ways, for example, based on the type of the user:

The following information may be recorded for card providers:
a. Menu options selected by the card provider on the server website.
b. Clicks or selections performed by the card provider including:
   i. Every time an “email” or “phone” button is clicked by a user, the action is recorded.
   ii. Every time a “Campaign” link is clicked, the action is recorded.
   iii. Every time the user's “Business Profile” is accessed, the answer is recorded.
   iv. Every time the user's “custom buttons” are clicked, the action is recorded.
c. Visits to social media links are tracked (e.g. time is recorded for every click).
d. Every time a lead chooses to upload his/her information to the user (e.g. through a microsite or mobile application), the information is recorded. This also includes the location of the lead uploading the information.
e. Lead information uploaded through the microsite, or mobile application (by scanning encoded objects on hybrid business cards) by a user is recorded and associated with the user (including location and comments from the lead).
   Other or different information may be used. Information collected based on user's behavior mentioned above or other information may be stored on the system server, and/or a separate analytics server. Each user action record of a click or other action may be sent to the server(s) via an API. The API, for example, provided by the server(s) may be invoked (e.g. using Hypertext Transfer Protocol Secure (HTTPS)) by the microsite, website or mobile application. The recorded user information may be used for deriving analytics regarding user's behavior such as:
a. Number of views of user's personal/business profile—over any given period of time.
b. Number of contacts created by the user (over a time span, and in total)
c. Number of visits to user's social links
d. Number of visits to user's custom buttons
e. Number of scanned cards
   Similar statistics may be collected on a “company” level. Since information is recorded for each individual user, and users may be grouped into companies, teams or other user groups, the server may calculate company or group related statistics by accumulating the individual user statistics for the group's members. Examples of such calculations may include for example:
1. Effectiveness of company campaigns (for example, by calculating how many people clicked on a campaign within a set period of time, the geographic locations of the users who clicked, etc.)
2. Effectiveness of a sales team in their ability to generate leads (for example, by counting the cumulative numbers of hybrid business card scans or contacts recorded for the sales team).
3. Effectiveness of messaging (for example, by calculating how many people clicked on campaigns, social links, etc.)

The following information may be recorded for leads/card recipients:
a. Clicks or selections performed by the lead including:
   i. Every time an “email” or “phone” button is clicked by a lead, the action is recorded.
   ii. Every time “Campaign” link is clicked, the action is recorded.
   iii. Every time the user's “Business Profile” is accessed, the answer is recorded.
   iv. Every time the user's “custom buttons” are clicked—the action is recorded.
b. Visits to social media links are being tracked (e.g. time is recorded for every click)
c. Every time a lead chooses to upload his/her information to the card provider (e.g. through a microsite or mobile application) the information is recorded. This recorded information may include the location of the lead uploading the information (e.g. location of residence, business or current device location).
   Information collected based on user's behavior such as that mentioned above or other information may be stored on the system server, and/or a separate analytics server. Each user action record of a click or other action may be sent to the server(s) via an API. The recorded user information may be used for deriving analytics regarding user's behavior.

Embodiments of the invention may provide a hybrid business card system for generating online analytics, measurement, and social connectivity from the exchange of hybrid business cards and other offline printed media. The system may include a campaign management sub-system, analytics sub-system and leads management sub-system wherein a user of the system may define their own business card related data, assign special, additional, digital content to the data including social media data and other information defined by the user and collect information regarding the usage of the card and its associated content. The system may provide a hybrid business card to deliver unique content targeted to multiple audiences served by an organization. The system may include multiple card scanning devices and mechanisms including QR scanning, Optical character recognition (OCR), NFC, and augmented reality. The system may provide local storage of hybrid business card data at the devices of the card recipient and provider for offline contact management. The system may record, monitor and analyze usage information of hybrid business card data, for example, as defined by the card provider.

Embodiments may include a user interface (e.g. mobile and/or web) for displaying a graphical representation of analytics collected specifically in regards to the usage of the hybrid business card and the information assigned to that hybrid business card by card provider (e.g., see statistics dashboard 1500 of FIG. 15). Analytics may include metrics such as usage information, social engagements, interactions with custom content, and relevant geographic location as well as an identifier of the device from which a hybrid business card or other media was scanned.

Embodiments may provide a social media management component wherein a user of the system may automatically connect to social media platforms pertinent to the user's desires and business goals. The system may provide a targeted marketing campaign management component enabling the delivery of marketing campaigns and other relevant content through a hybrid business card. The campaign may include start and end dates, digital information related to the campaign, access limitation rules and a url representation of the campaign. The system may also provide detailed analytics related to campaigns which are presented in the statistics dashboard.

Embodiments may include an enterprise management system wherein an enterprise may create organizational boundaries for its employees, manage the distribution of campaigns to targeted constituencies and produce analytics to measure the results. The enterprise management system may further include a sub-system that allows an enterprise to define enterprise wide parameters that are specific to the enterprise and affect the enterprise members and the information assigned to the members business cards. The enterprise management system may further include a sub-system to manage said employees and to allow access to the leads generated by the said employees. The system may include a sub-system to analyze and display the business information generated by said employees including a graphical representation of card recipients'responsiveness to the employees' business cards and the effectiveness of the business campaigns.

Embodiments of the invention may be software-implemented using dedicated instruction(s) or, alternatively, hardware-implemented using designated circuitry and/or logic arrays.

Embodiments of the invention may include an article such as a computer or processor readable non-transitory storage medium, such as for example a memory (e.g., memor(ies) 116 of FIG. 1), a disk drive, or a USB flash memory encoding, including or storing instructions, e.g., computer-executable instructions, which when executed by a processor or controller (e.g., processor(s) 114 of FIG. 1), cause the processor or controller to carry out methods disclosed herein.

Different embodiments are disclosed herein. Features of certain embodiments may be combined with features of other embodiments; thus certain embodiments may be combinations of features of multiple embodiments.

Although the particular embodiments shown and described above will prove to be useful for the many distribution systems to which the present invention pertains, further modifications of the present invention will occur to persons skilled in the art. All such modifications are deemed to be within the scope and spirit of the present invention as defined by the appended claims.

1. A method for exchanging information comprising:
receiving information relating to a hybrid business card, the hybrid business card having printed thereon information providing a link to a virtual profile for a first user;
receiving identity information for a second user, the identity information associated with the information related to the hybrid business card;
in response to receiving the information relating to the hybrid business card, providing the second user with access to the virtual profile including information relating to the first user or to an organization associated with the first user; and
recording interactions of the second user related to the first user.

2. The method of claim 1 comprising monitoring the recorded interactions of the second user and reporting the recorded interactions of the second user to the first user.

3. The method of claim 1 comprising generating a contact map to visualize the first user's network of virtual contacts including the second user.

4. The method of claim 3, wherein the contact map shows the geographic locations where the information relating to the hybrid business card is received.

5. The method of claim 1 comprising providing access to one or more authorized users to edit the virtual profile for the first user to provide dynamic content to the second user.

6. The method of claim 1 comprising automatically sending updates of the first user's virtual profile to the second user.

7. A method for exchanging information comprising:
using a hybrid business card associated with a user and having printed thereon an encoded object providing a link to a virtual profile for the user, receiving a request from a device scanning the encoded object; and
in response to receiving the request, providing the scanning device with access to the link of the virtual profile.

8. The method of claim 7 comprising generating a contact map to visualize each user's network of virtual contacts including hybrid business card recipients that have scanned the user's hybrid business card.

9. The method of claim 8, wherein the contact map shows the geographic locations where the user's hybrid business card was scanned.

10. The method of claim 7 comprising providing a web dashboard to manage the content of the virtual profile.

11. The method of claim 7 comprising providing access to one or more authorized users to edit the virtual profile to provide dynamic content to the recipient of the hybrid business card.

12. The method of claim 7 comprising sending updates of the user's virtual profile to each user's virtual contacts that scanned the user's hybrid business card.

13. The method of claim 7 comprising monitoring hybrid business card statistics in real-time, the statistics comprising the number of recipients that scan each user's hybrid business card, the number of recipients that access the virtual profile of each user, or the number of contacts in the user's network.

14. The method of claim 7 comprising further providing a link to the virtual profile by sending a virtual business card via electronic mail (e-mail), text messaging, near field communication (NFC), or augmented reality.

15. The method of claim 7, wherein the encoded object is a matrix barcode.

16. A method for providing a social media environment for sharing business cards, the method comprising:
receiving a request for digital profile information of a user, the user identified for the request using a business card associated with the user;
generating for the user a network of contacts that have requested the user's digital profile information using the user's business card; and
sharing the user's digital profile information with the contacts in the network of contacts.

17. The method of claim 16 comprising generating a contact map to visualize each user's network of contacts.

18. The method of claim 17, wherein the contact map shows the geographic locations where the network of contacts requested the user's digital profile information.

19. The method of claim 16 comprising providing a web dashboard to manage the content of the virtual profile, generate online analytics, measurement, and social connectivity from the exchange of business cards.

20. The method of claim 16, wherein the user's business card is a physical business card, a virtual business card or a hybrid business card comprising a physical component linked to a digital component.

21. The system of claim 16, wherein the request comprises scanning an encoded object printed on a physical business card or accessing a link on a digital business card.

22. A system for exchanging information comprising:
a database to store virtual profiles comprising information relating to a user or to an organization; and
a server configured to:
receive information relating to a hybrid business card, the hybrid business card having printed thereon information providing a link to a virtual profile for a first user;
receive identity information for a second user, the identity information associated with the information related to the hybrid business card;
in response to the information relating to the hybrid business card, link the second user to the virtual profile for the first user for providing the second user with information relating to the first user or to an organization associated with the first user; and
record interactions by the second user related to the first user.
